(19) United States
(12) Patent Application Publication
(10) Pub. No.: US 2013/0094765 A1
(43) Pub. Date: Apr. 18, 2013

(54) METHOD FOR DETECTING BLACK RIM OF IMAGE FRAME AND IMAGE PROCESSING APPARATUS USING THE SAME

(71) Applicants: Yu-Shu Liu, Hsinchu City (TW); Chun-Wei Chen, Taipei City (TW); Jian-de Jiang, Shaanxi Province (CN); Chun Wang, Shanghai City (CN)

(72) Inventors: Yu-Shu Liu, Hsinchu City (TW); Chun-Wei Chen, Taipei City (TW); Jian-de Jiang, Shaanxi Province (CN); Chun Wang, Shanghai City (CN)

(73) Assignee: Novatek Microelectronics Corp., Hsinchu (TW)

(21) Appl. No.: 13/397,676

(22) Filed: Feb. 16, 2012

(30) Foreign Application Priority Data
Oct. 14, 2011 (TW) 100137354

(51) Int. Cl. G06K 9/48

(52) U.S. Cl. 382/199

(57) ABSTRACT

A method for detecting a black rim of an image frame is provided. The method includes following steps. Rim brightness information of a rim region of a current image frame is calculated. Frame brightness information of a frame region of the current image frame is obtained. A brightness threshold is calculated according to the rim brightness information and the frame brightness information. Whether a plurality of pixels in the rim region are black pixels is determined according to the brightness threshold. Furthermore, an image processing apparatus is also provided.

### CROSS-REFERENCE TO RELATED APPLICATION

This application claims the priority benefit of Taiwan application serial no. 100137354, filed on Oct. 14, 2011. The entirety of the above-mentioned patent application is hereby incorporated by reference herein and made a part of this specification.

### BACKGROUND OF THE INVENTION

1. Field of the Invention

The present invention relates to an image detecting method and an image processing apparatus, and more particularly relates to a method for detecting a black rim of an image frame and an image processing apparatus using the same.

2. Description of Related Art

To achieve an optimal cutting method, the size of the current display panel is developed from the traditional screen with narrow aspect ratio to the wide screen. The wide screen frame reduces the visual difference between the movie and the display apparatus to some extent, and also gives a stronger visual impact for the viewer when watching the frame. Due to the above advantages, the image signal in the wide screen playback format will naturally become the mainstream in the future.

However, for the image signal in the playback format with any aspect ratio, the corresponding image frame has a black rim region before playback. Therefore, an image processing apparatus needs to detect the black rim on the black rim region so as to enable the display to properly play back the image frame intended by the user. In the prior art, the image processing apparatus usually employs a constant brightness threshold (or referred to as a black pixel threshold) for detecting the black rim, so as to determine whether the pixels in the rim region are black pixels. However, for the image frames with different brightness, the constant brightness threshold may cause unstable detection of the black rim or even fail to detect the black rim, resulting in unsatisfactory display quality of the image frame.

### SUMMARY OF THE INVENTION

The disclosure provides a method for detecting a black rim of an image frame, in which a brightness threshold may be adjusted in accordance with frame brightness.

The disclosure further provides an image processing apparatus, in which the brightness threshold may be adjusted in accordance with the frame brightness.

In an aspect, a method for detecting a black rim of an image frame is provided, including following steps. Rim brightness information of a rim region of a current image frame is calculated. Frame brightness information of a frame region of the current image frame is obtained. A brightness threshold is calculated according to the rim brightness information and the frame brightness information. Whether a plurality of pixels in the rim region are black pixels is determined according to the brightness threshold.

In an embodiment of the present invention, the step of calculating the rim brightness information of the rim region of the current image frame includes the following steps. Sub rim brightness information of one or more sub rim regions of the rim region is calculated. The rim brightness information is calculated according to the sub rim brightness information of the one or more sub rim regions.

In an embodiment of the present invention, the step of calculating the sub rim brightness information of the sub rim includes calculating one to plural of the following brightness values of each sub rim region: an average brightness value of each sub rim region, a maximum brightness value of a plurality of regions of each sub rim region, a minimum brightness value of the plurality of regions of each sub rim region and an average brightness value of one or more specific rows or one or more specific columns in each sub rim region.

In an embodiment of the present invention, the method for detecting a black rim further includes discarding one brightness value having the maximum difference from other brightness value among the calculated one to plural brightness values of each sub rim region.

In an embodiment of the present invention, one or more specific rows or one or more specific columns in each sub rim region are a border row or a border column on the outermost side of the screen in each sub rim region.

In an embodiment of the present invention, the step of calculating the rim brightness information according to the sub rim brightness information of the one to plural sub rim regions includes calculating an average brightness value of the sub rim brightness information of the one to plural sub rim regions to serve as the rim brightness information.

In an embodiment of the present invention, the frame brightness information includes an average brightness value of the frame region.

In an embodiment of the present invention, the step of calculating the brightness threshold according to the rim brightness information and the frame brightness information includes obtaining a first brightness threshold based on an adjustment parameter according to the average brightness value and the brightness information of the frame, so as to serve as a basis for generating the brightness threshold.

In an embodiment of the present invention, the method for detecting a black rim further includes obtaining a second brightness threshold to serve as the brightness threshold according to the first brightness threshold of the one or more previous image frames and the first brightness threshold of the current image frame.

In an embodiment of the present invention, the step of determining whether the plurality of pixels in the rim region are black pixels according to the brightness threshold includes following steps. The brightness of the plurality of pixels in the rim region and the brightness threshold are compared. The pixels are determined to be black pixels if the brightness of the detected pixels is smaller than the brightness threshold.

In another aspect, an image processing apparatus is provided, which includes a rim information calculation unit, a threshold calculation unit and a black rim detection unit. The rim information calculation unit calculates rim brightness information of a rim region of a current image frame. The threshold calculation unit calculates a first brightness threshold according to the rim brightness information and frame brightness information of a frame region of the current image frame. The black rim detection unit determines whether a plurality of pixels in the rim region are black pixels according to the first brightness threshold.

In an embodiment of the present invention, the rim information calculation unit includes a brightness calculation unit. The brightness calculation unit calculates sub rim brightness information of one or more sub rim regions of a rim region to be provided to the rim information calculation unit for calculating the rim brightness information according to the sub rim brightness information of the one or more sub rim regions.

In an embodiment of the present invention, the calculating the sub rim brightness information of the sub rim by the brightness calculation unit includes calculating one to plural of the following brightness values of each sub rim region: an average brightness value of each sub rim region, a maximum brightness value of a plurality of regions of each sub rim region, a minimum brightness value of the plurality of regions of each sub rim region and an average brightness value of one or more specific rows or one or more specific columns in each sub rim region.

In an embodiment of the present invention, the rim information calculation unit further includes a brightness selection unit. The brightness selection unit discards one brightness value having the maximum difference from other brightness values among the calculated one to plural brightness values of each sub rim region.

In an embodiment of the present invention, one or more specific rows or one or more specific columns in each sub rim region are a border row or a border column on the outermost side of the screen in each sub rim region.

In an embodiment of the present invention, the rim information calculation unit further includes a brightness equalization unit. The brightness equalization unit calculates an average brightness value of the sub rim brightness information of the one to plural sub rim regions to serve as the rim brightness information.

In an embodiment of the present invention, the frame brightness information includes an average brightness value of the frame region.

In an embodiment of the present invention, the threshold calculation unit obtains the first brightness threshold based on an adjustment parameter according to the average brightness value and the brightness information of the frame so as to serve as a basis for generating the brightness threshold.

In an embodiment of the present invention, the image processing apparatus further includes a threshold adjustment unit. The threshold adjustment unit obtains a second brightness threshold according to the first brightness threshold of the one or more previous image frames and the first brightness threshold of the current image frame, so as to be provided to the black rim detection unit.

In an embodiment of the present invention, the black rim detection unit compares the brightness of the plurality of pixels in the rim region with the brightness threshold and determines the pixels are black pixels if the brightness of the detected pixels is smaller than the brightness threshold.

In exemplary embodiments of the present invention, the brightness threshold in the method for detecting a black rim can be adjusted according to the brightness information of the rim region and the average brightness value of the image frame. Therefore, the exemplary embodiments of the present invention may increase the detection stability of the black rim and improve the display quality of the image frame.

In order to make the aforementioned features and advantages of the present invention more comprehensible, the exemplary embodiments are illustrated in detail hereinafter with reference to accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A to 1C illustrate an image frame according to an embodiment of the present invention;

FIG. 2 is a schematic block view of an image processing apparatus according to an embodiment of the present invention;

FIG. 3 is a schematic block view of an interior of a rim detection unit 240 in FIG. 2;

FIG. 4 illustrates a curve relationship between an adjustment parameter β and frame brightness information Y2 according to an embodiment of the present invention; and

FIG. 5 is a flow chart of a method for detecting a black rim according to an embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

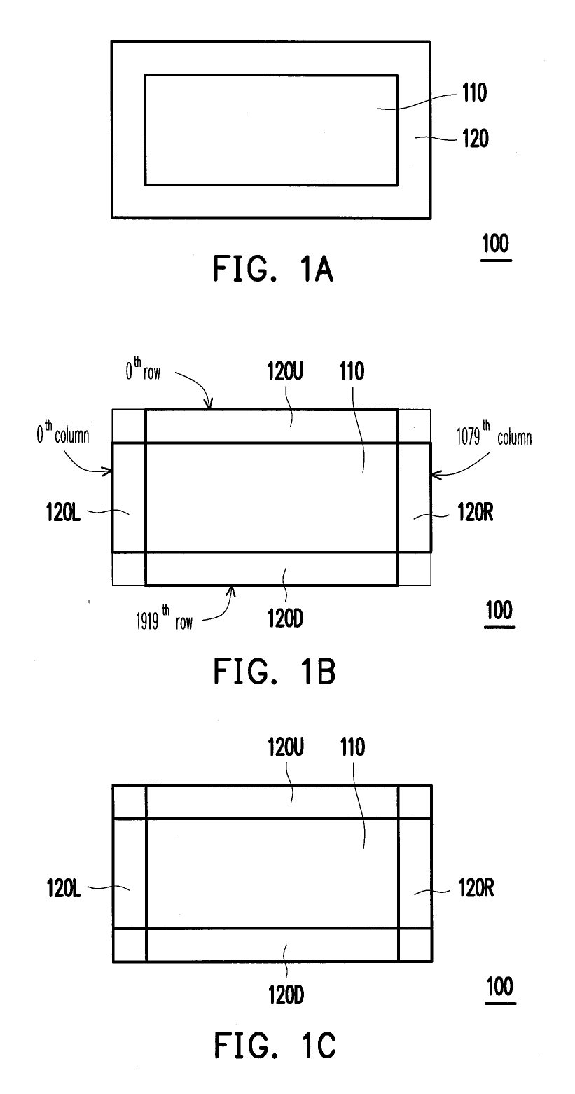

FIGS. 1A to 1C illustrate an image frame according to an embodiment of the present invention. Referring to FIGS. 1A to 1C, in this embodiment, the image frame 100 includes a frame region 110 and a rim region 120. The frame region 110 is image content displayed on the screen when a display plays back the image frame 100 and is the image frame which a user intends to view, and the rim region 120 is a black block surrounding the frame region 110. The rim region 120 of this embodiment may be divided into a plurality of sub rim regions, such as a top rim region 120U, a bottom rim region 120D, a left rim region 120L and a right rim region 120R as shown in FIG. 1B, and the sub rim regions are not overlapped with each other. Alternatively, the rim region 120 of this embodiment may also be divided into a plurality of partially overlapped sub rim regions 120U, 120D, 120L, 120R as shown in FIG. 1C.

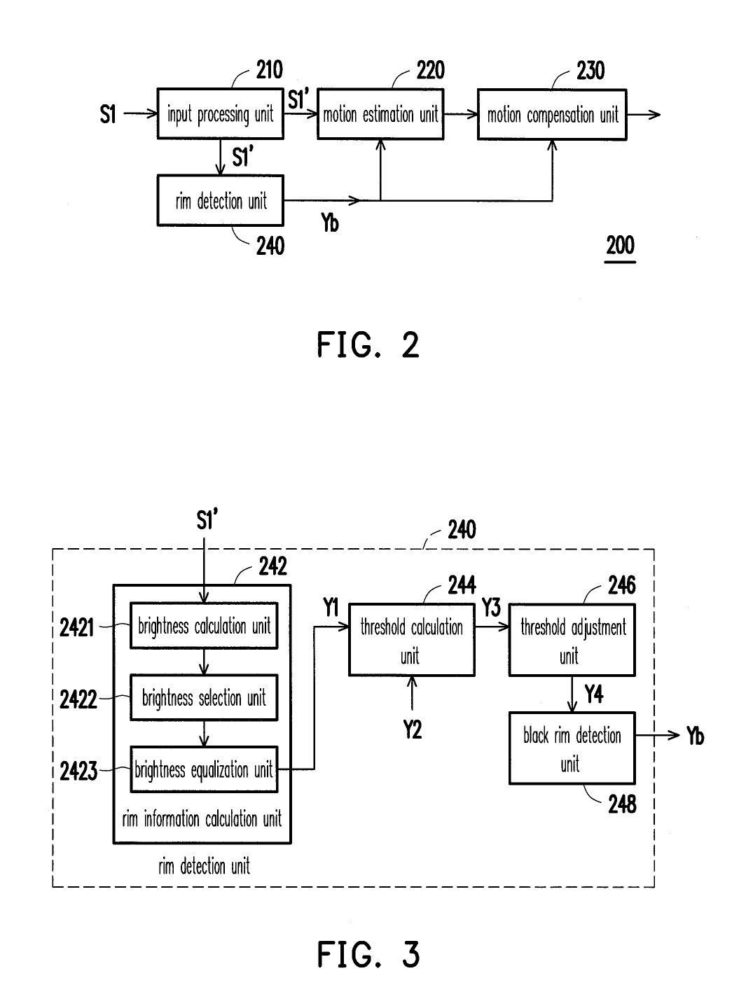

FIG. 2 is a schematic block view of an image processing apparatus according to an embodiment of the present invention. Referring to FIG. 2, in this embodiment, the image processing apparatus 200 includes an input processing unit 210, a motion estimation unit 220, a motion compensation unit 230 and a rim detection unit 240. The input processing unit 210 is adapted to receive an input image signal S1, so as to perform a prepositive image processing on the image signal S1 and output the processed image signal S1′ to the motion estimation unit 220 and the rim detection unit 240. For example, the input processing unit 210 detects the current image frame 100 of the image signal S1, so as to decide a range of the rim region 120 of the current image frame 100 and output the detection result of the input processing unit 210 to the rim detection unit 240, so that the rim detection unit 240 may continue to perform black rim detection on the current image frame 100 of the image signal S1, so as to obtain black rim detection information Yb. Furthermore, the motion estimation unit 220 and the motion compensation unit 230 are used to perform motion estimation and motion compensation (MEMC) on the image signal S1, which will not be described in details herein. The black rim detection unit 248 outputs the black rim detection information Yb to the motion estimation unit 220 and the motion compensation unit 230 to serve as a reference for image processing.

FIG. 3 is a schematic block view of an interior of a rim detection unit 240 in FIG. 2. Referring to FIGS. 1A to 3 together, the rim detection unit 240 of this embodiment includes a rim information calculation unit 242, a threshold calculation unit 244, a threshold adjustment unit 246 and a black rim detection unit 248.

In this embodiment, the rim information calculation unit 242 receives the image signal S1′ output by the input processing unit 210 to obtain the image information of each sub rim region of the rim region 120. Herein, each sub rim region includes a plurality of pixel blocks, a plurality of pixel rows and a plurality of pixel columns. Taking a frame with a resolution of 1920×1080 as an example, each pixel block for example includes 4×4 pixels, and each pixel row includes 1920 pixels and each pixel column includes 1080 pixels, but the present invention is not limited to this.

It should be noted that, the rim region 120 detected by the rim detection unit 240 may be divided into a plurality of sub rim regions 120U, 120D, 120L, 120R which are not overlapped with each other as shown in FIG. 1B, but the present invention is not limited to this. In other embodiments, the rim region 120 detected by the rim detection unit 240 may also for example include a plurality of sub rim regions 120U, 120D, 120L, 120R which are partially overlapped as shown in FIG. 1C.

Then, the rim information calculation unit 242 is configured to calculate the brightness related information of the rim. FIG. 3 is also a schematic block view of a rim information calculation unit 242 according to an embodiment, which includes a brightness calculation unit 2421, a brightness selection unit 2422 and a brightness equalization unit 2423.

The brightness calculation unit 2421 is used to calculate the sub rim brightness information of one to plural sub rim regions 120U, 120D, 120L, 120R. Preferably, each sub rim brightness information includes one or more of the following brightness values: an average brightness value of the sub rim region, an average brightness value of one or more specific pixel rows or specific pixel columns in the sub rim region, and a maximum brightness value and a minimum brightness value of a plurality of blocks in the sub rim region.

In an exemplary embodiment, the one or more specific pixel rows or specific pixel columns are set to be a border row or a border column on the outermost side (i.e. farthest from the frame region 110) of the screen in each sub rim region. Specifically, the specific pixel row/column is the pixel row (i.e. the 0^{th} row) on the top of the screen in the top rim region 120U; the 1079^{th} row of pixels on the bottom of the screen in the bottom rim region 120D; the 0^{th} column on the most left side of the screen and the 1919^{th} column on the most right side of the screen in the sub rim regions 120L, 120R respectively, but the present invention is not limited to this.

Taking the top rim region 120U as an example, the brightness calculation unit 2421 calculates the pixels in the top rim region 120U according to the image information provided by the input processing unit 210 so as to obtain four pieces of brightness information including the average brightness value of the top rim region 120U, the maximum brightness value and the minimum brightness value of the blocks in the top rim region 120U, and the average brightness value of the 0^{th} row of pixels in the top rim region 120U, but the present invention is not limited to this. Likewise, the brightness calculation unit 2421 also separately calculates the sub rim brightness information of the sub rim regions 120D, 120L, 120R.

Thereafter, the brightness selection unit 2422 separately selects at least one applicable brightness value for the sub rim brightness information of sub rim regions 120D, 120L, 120R and provides the at least one applicable brightness value to the brightness equalization unit 2423. Preferably, after receiving four brightness values of each region, the brightness selection unit 2422 discards one brightness value having the maximum difference from other brightness values and reserves other brightness values, thereby avoiding the subsequent misjudgement of the brightness threshold caused by the misjudgement of logo, noise or rim.

Then, after obtaining the brightness values with the small difference of the sub rim regions 120D, 120L, 120R, the brightness equalization unit 2423 further averages the sub rim brightness information of all the sub rim regions (for example, one brightness value with the small difference among the four brightness values of each sub rim region), and then provides the average brightness value serving as the rim brightness information Y1 to the threshold calculation unit 244.

It should be noted that the brightness selection unit 2422 may be removed in other embodiments. In other words, the brightness equalization unit 2423 calculates the sub rim brightness information of each sub rim region provided by the brightness calculation unit 2421 to obtain an average brightness value. More specifically, the rim brightness information calculated by the rim information calculation unit 242 is the average brightness value of one to plural brightness values of one sub rim region or the average brightness value of one to plural brightness values of a plurality of sub rim regions.

Afterwards, the threshold calculation unit 244 obtains a first brightness threshold Y3 according to the rim brightness information Y1 and the frame brightness information Y2 of the current image frame 100 provided by the rim information calculation unit 242. The threshold calculation unit 244 then outputs the first brightness threshold Y3 to the threshold adjustment unit 246. The frame brightness information Y2 includes the brightness related information of the frame region 110 of the image frame 100, such as the average brightness value of all pixels of the frame region 110 of the image frame 100, i.e. the global average pixel level.

In a specific embodiment, the threshold calculation unit 244 obtains the first brightness threshold Y3 based on an adjustment parameter β according to the current frame brightness information Y2 and the rim brightness information Y1. For example, the threshold calculation unit 244 calculates according to the formula Y3=Y1(1−β)+Y2×β to obtain the first brightness threshold Y3. The adjustment parameter β may be determined according to the frame brightness information Y2 (such as the global average pixel level).

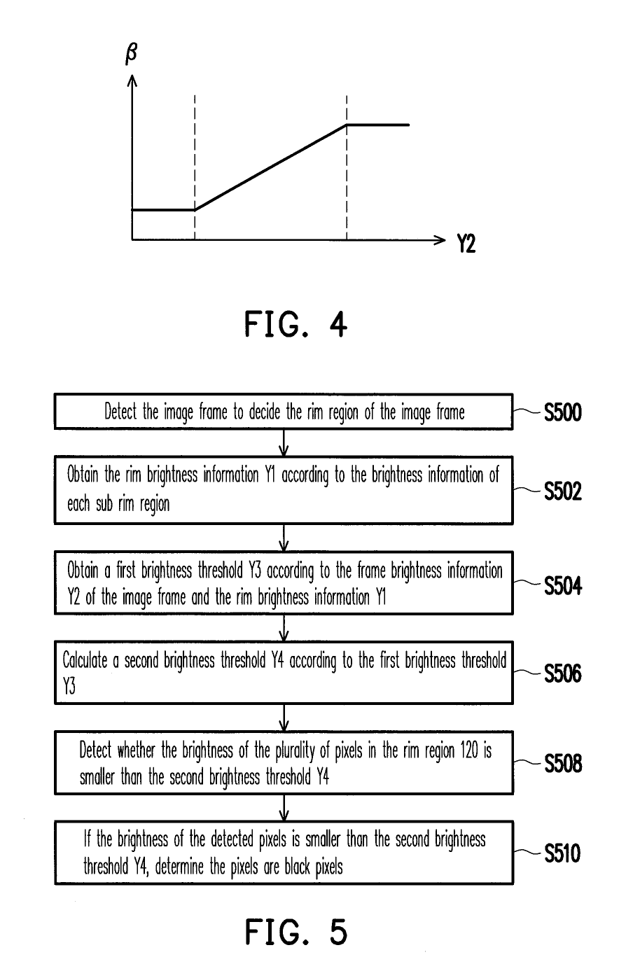

Referring to FIG. 4 at the same time, FIG. 4 illustrates a curve relationship between an adjustment parameter and frame brightness information Y2 according to an embodiment of the present invention. In other words, the value of the adjustment parameter β may be determined by a curve relationship between the adjustment parameter β and the frame brightness information Y2 in FIG. 4, where β<1.

Referring back to FIG. 3, after the threshold adjustment unit 246 receives the first brightness threshold Y3, a second brightness threshold Y4 is obtained according to the first brightness threshold Y3 and provided to the black rim detection unit 248. Preferably, the threshold adjustment unit 246 is for example implemented by an Infinite Impulse Response (IIR) filter.

In an embodiment, the threshold adjustment unit 246 calculates the second brightness threshold Y4 according to the first brightness threshold Y3′ (not shown) of the previous image frame and the first brightness threshold Y3 of the current image frame. For example, the threshold adjustment unit 246 obtains the second brightness threshold Y4 according to the formula Y4=α₁Y3′+α₂Y3, in which the weight values α₁, and α₂ of the first brightness threshold Y3′ and Y3 may be adjusted according to the design requirements.

Furthermore, in other embodiments, the threshold adjustment unit 246 may calculate the second brightness threshold Y4 merely according to the current first brightness threshold Y3, that is α₁=0 in this case. That is to say, after the threshold calculation unit 244 obtains the first brightness threshold Y3 according to the current frame brightness information Y2 and the rim brightness information Y1, the threshold adjustment unit 246 adjusts the second brightness threshold Y4 merely according to the current first brightness threshold Y3.

Furthermore, in other embodiments, the threshold adjustment unit 246 may also adjust the first brightness threshold Y3 according to the first brightness thresholds of more previous image frames to obtain the second brightness threshold Y4.

Thereafter, the black rim detection unit 248 determines whether a plurality of pixels in the rim region 120 are black pixels according to the second brightness threshold Y4 provided by the threshold adjustment unit 246. Preferably, the black rim detection unit 248 detects whether the brightness of the plurality of pixels in the rim region 120 is smaller than the second brightness threshold Y4. If the brightness of the detected pixels is smaller than the brightness threshold, the black rim detection unit 248 determines the pixels are black pixels.

At last, the black rim detection unit 248 outputs the black rim detection information Yb representing the black rim detection result to the motion estimation unit 220 and the motion compensation unit 230 to serve as the reference for image processing.

It should be noted that the threshold adjustment unit 246 is adapted to further adjust the first brightness threshold Y3, but the present invention is not limited to this. For example, in other embodiments, the threshold calculation unit 244 may directly provide the first brightness threshold Y3 to the black rim detection unit 248.

After the configuration, the brightness threshold for detecting a black rim may be adjusted according to the brightness information of the rim region and the average brightness value of the image frame. Therefore, the present invention may increase the detection stability of the black rim and improve the display quality of the image frame.

FIG. 5 is a flow chart of a method for detecting a black rim according to an embodiment of the present invention. Referring to FIGS. 1A to 5, the method for detecting a black rim of this embodiment includes the following steps.

Firstly, in step S500, the input processing unit 210 detects the image frame, so as to decide the rim region of the image frame. Then, in step S502, the rim information calculation unit 242 obtains the brightness information of the rim region, i.e. the rim brightness information Y1 according to the brightness information of each sub rim region. In this embodiment, the brightness information of each sub rim region for example includes an average brightness value of each sub rim region, the maximum brightness value and the minimum brightness value of the blocks in each sub rim region, and the average brightness value of the specific pixel row or the specific pixel column in each sub rim region. Thereafter, in step S504, the threshold calculation unit 244 obtains a first brightness threshold Y3 according to the brightness information of the frame region of the image frame, i.e. the frame brightness information Y2 (preferably the global average pixel level) and the rim brightness information Y1. Afterwards, in step S506, the threshold adjustment unit 246 calculates a second brightness threshold Y4 according to the first brightness threshold Y3. Then, in step S508, the black rim detection unit 248 detects whether the brightness of the plurality of pixels in the rim region 120 is smaller than the second brightness threshold Y4. In step S510, if the brightness of the detected pixels is smaller than the second brightness threshold Y4, the black rim detection unit 248 determines the pixels are black pixels.

Furthermore, the method for detecting a black rim in this embodiment may be understood from the teachings, suggestions and implementations explained in the exemplary embodiments of FIGS. 1A to 4, and the details will not be repeated herein.

In view of the above, in the embodiments of the present invention, the brightness threshold for detecting the black rim may be adjusted according to the brightness information of the rim region and the average brightness value of the image frame. Therefore, the embodiments of the present invention may increase the detection stability of the black rim and improve the display quality of the image frame.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for detecting a black rim of an image frame, comprising:
calculating rim brightness information of a rim region of a current image frame;
obtaining frame brightness information of a frame region of the current image frame;
calculating a brightness threshold according to the rim brightness information and the frame brightness information; and
determining whether a plurality of pixels in the rim region are black pixels according to the brightness threshold.

2. The method for detecting a black rim according to claim 1, wherein the step of calculating the rim brightness information of the rim region of the current image frame comprises:
calculating sub rim brightness information of one or more sub rim regions of the rim region; and
calculating the rim brightness information according to the sub rim brightness information of the one or more sub rim regions.

3. The method for detecting a black rim according to claim 2, wherein the step of calculating the sub rim brightness information of the sub rim regions comprises calculating one to plural of the following brightness values of each sub rim region: an average brightness value of each sub rim region, a maximum brightness value of a plurality of regions of each sub rim region, a minimum brightness value of the plurality of regions of each sub rim region and an average brightness value of one or more specific rows or one or more specific columns in each sub rim region.

4. The method for detecting a black rim according to claim 3, further comprising discarding one brightness value provided with the maximum difference from other brightness values among the calculated one to plural brightness values of each sub rim region.

5. The method for detecting a black rim according to claim 3, wherein the one or more specific rows or the one or more specific columns in each sub rim region are a border row or a border column on the outermost side of a screen in each sub rim region.

6. The method for detecting a black rim according to claim 2, wherein the step of calculating the rim brightness information according to the sub rim brightness information of the one to plural sub rim regions comprises calculating an average brightness value of the sub rim brightness information of the one to plural sub rim regions to serve as the rim brightness information.

7. The method for detecting a black rim according to claim 1, wherein the frame brightness information comprises an average brightness value of the frame region.

8. The method for detecting a black rim according to claim 1, wherein the step of calculating the brightness threshold according to the rim brightness information and the frame brightness information comprises:
obtaining a first brightness threshold based on an adjustment parameter according to an average brightness value and the brightness information of the current image frame, so as to serve as a basis for generating the brightness threshold.

9. The method for detecting a black rim according to claim 8, further comprising:
obtaining a second brightness threshold to serve as the brightness threshold according to a first brightness threshold of the one or more previous image frames and the first brightness threshold of the current image frame.

10. The method for detecting a black rim according to claim 1, wherein the step of determining whether the plurality of pixels in the rim region are black pixels according to the brightness threshold comprises:
comparing brightness of the plurality of pixels in the rim region with the brightness threshold; and
determining the pixels are black pixels if the brightness of the detected pixels is smaller than the brightness threshold.

11. An image processing apparatus, comprising:
a rim information calculation unit, calculating rim brightness information of a rim region of a current image frame;
a threshold calculation unit, calculating a brightness threshold according to the rim brightness information and frame brightness information of a frame region of the current image frame; and
a black rim detection unit, determining whether a plurality of pixels in the rim region are black pixels according to the brightness threshold.

12. The image processing apparatus according to claim 11, wherein the rim information calculation unit comprises a brightness calculation unit, calculating sub rim brightness information of one or more sub rim regions of the rim region to be provided to the rim information calculation unit for calculating the rim brightness information according to the sub rim brightness information of the one or more sub rim regions.

13. The image processing apparatus according to claim 12, wherein the calculating the sub rim brightness information of the sub rim regions by the brightness calculation unit comprises calculating one to plural of the following brightness values of each sub rim region: an average brightness value of each sub rim region, a maximum brightness value of a plurality of regions of each sub rim region, a minimum brightness value of the plurality of regions of each sub rim region and an average brightness value of one or more specific rows or one or more specific columns in each sub rim region.

14. The image processing apparatus according to claim 13, wherein the rim information calculation unit further comprises a brightness selection unit, for discarding one brightness value provided with the maximum difference from other brightness values among the calculated one to plural brightness values of each sub rim region.

15. The image processing apparatus according to claim 13, wherein the one or more specific rows or the one or more specific columns in each sub rim region are a border row or a border column on the outermost side of a screen in each sub rim region.

16. The image processing apparatus according to claim 12, wherein the rim information calculation unit further comprises a brightness equalization unit, for calculating an average brightness value of the sub rim brightness information of the one to plural sub rim regions to serve as the rim brightness information.

17. The image processing apparatus according to claim 11, wherein the frame brightness information comprises an average brightness value of the frame region.

18. The image processing apparatus according to claim 11, wherein the threshold calculation unit obtains a first brightness threshold based on an adjustment parameter according to an average brightness value and the brightness information of the current image frame so as to serve as a basis for generating the brightness threshold.

19. The image processing apparatus according to claim 18, further comprising a threshold adjustment unit, for obtaining a second brightness threshold according to a first brightness threshold of the one or more previous image frames and the first brightness threshold of the current image frame, so as to be provided to the black rim detection unit.

20. The image processing apparatus according to claim 11, wherein the black rim detection unit compares brightness of the plurality of pixels in the rim region with the brightness threshold, and determines the pixels are black pixels if the brightness of the detected pixels is smaller than the brightness threshold.
